(19) United States
(12) Patent Application Publication
(10) Pub. No.: US 2020/0345456 A1
(43) Pub. Date: Nov. 5, 2020

(54) BENDING ANGLE CONTROL MEANS AND BENDING ANGLE CONTROL METHOD

(71) Applicants: YOUN HO JUNG, Seoul (KR); JAE WOONG JUNG, Seoul (KR)

(72) Inventors: YOUN HO JUNG, Seoul (KR); JAE WOONG JUNG, Seoul (KR); KWANG GU BAEK, Gyeonggi-do (KR); YOON SANG SHIN, Seoul (KR)

(21) Appl. No.: 16/401,338

(22) Filed: May 2, 2019

(51) Int. Cl. A61C 7/00; A61C 7/20

(52) U.S. Cl. CPC A61C 7/002; A61C 7/20

(57) ABSTRACT

A bending angle control means of a wire bending apparatus that includes a holding portion configured to hold at least a part of a dental wire and a bending portion configured to bend a predetermined portion of the dental wire held by the holding portion includes a storage unit in which data on a required bending angle in accordance with a position of the dental wire is stored, a bending angle calculator configured to calculate an applicable bending angle by adding an additional bending angle to the required bending angle in accordance with the position of the dental wire in consideration of a resilient restoring force, a measurer configured to measure an actual bending angle of the dental wire bent by the applicable bending angle, an error calculator configured to calculate an error between the actual bending angle and the required bend angle, and an additional bending angle corrector configured to correct the additional bending angle by applying the error.

### BACKGROUND

### 1. Field

The following description relates to a bending angle control means and a bending angle control method.

### 2. Description of Related Art

Recently, orthodontic treatment has become increasingly common in addition to medical care required to improve oral hygiene and maintain healthy teeth. Orthodontic treatment refers to the remedial actions that not only align crooked teeth, but also correct various skeletal incompatibilities in the teeth and mouth that may occur during the growth process so that the teeth can perform their normal functions. In addition, the treatment may result in a healthy oral tissue and a more beautiful facial appearance.

In this case, an orthodontic appliance fabricated with orthodontic wires is generally used in orthodontic treatment, wherein the structure and shape of the orthodontic wires may be formed differently according to a tooth structure, such as the tooth arrangement and shape of an orthodontic patient.

That is, the orthodontic appliance should be precisely shaped according to the oral structure of the patient to be treated, and the shaping of the orthodontic wires is often manually carried out by a skilled technician.

However, when the orthodontic appliance is shaped manually by a skilled technician, there was a problem in that quality may vary depending on the skill of the technician, and the orthodontic appliance accounted for a large portion of the cost of orthodontic treatment due to the cost incurred by manual labor of the skilled technician and time burden.

Accordingly, in order to address the cost increase due to the manual shaping of the orthodontic appliance, an apparatus for automatically bending the orthodontic wires has been proposed.

However, it is difficult to secure a sufficient degree of precision for orthodontic treatment even when a bending angle in accordance with a position is input and the wire is bent according to the bending angle. In particular, due to the nature of a material of the wire, i.e. the property of restoration to its original state, the wire is not bent to a desired degree so that the wire cannot be bent into an accurate shape.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

The disclosed embodiments are intended to provide a bending angle control means applied to a wire bending apparatus capable of bending a dental wire by a predetermined angle at predetermined intervals of length and thereby automatically fabricating an orthodontic appliance of a predetermined shape, and a method of controlling a bending angle.

In addition, the disclosed embodiments are intended to provide a bending angle control means and a bending angle control method which are capable of adjusting a bending angle by accurately applying a resilient restoring force of a dental wire

In one general aspect, a bending angle control means of a wire bending apparatus which comprises a holding portion configured to hold at least a part of a dental wire and a bending portion configured to bend a predetermined portion of the dental wire held by the holding portion includes a storage unit in which data on a required bending angle in accordance with a position of the dental wire is stored; a bending angle calculator configured to calculate an applicable bending angle by adding an additional bending angle to the required bending angle in accordance with the position of the dental wire in consideration of a resilient restoring force; a measurer configured to measure an actual bending angle of the dental wire bent by the applicable bending angle; an error calculator configured to calculate an error between the actual bending angle and the required bend angle; and an additional bending angle corrector configured to correct the additional bending angle by applying the error.

The additional bending angle may vary according to a kind of the dental wire.

The bending portion may be rotated by a rotational force of a motor and a bending projection eccentric to a rotational axis of the bending portion may push the dental wire so that the dental wire is bent.

The required bending angle in accordance with the position of the dental wire may be determined by tooth status data obtained by three-dimensionally scanning a patient.

The additional bending angle may be determined by a table including a value of the additional bending angle corresponding to a value of the required bending angle.

In another general aspect, a bending angle control method of a wire bending apparatus which comprises a holding portion configured to hold at least a part of a dental wire and a bending portion configured to bend a predetermined portion of the dental wire held by the holding portion includes storing data on a required bending angle in accordance with a position of the dental wire; calculating an applicable bending angle by adding an additional bending angle to the required bending angle in accordance with the position of the dental wire in consideration of a resilient restoring force; measuring an actual bending angle of the dental wire bent by the applicable bending angle; calculating an error between the actual bending angle and the required bend angle; and correcting the additional bending angle by applying the error.

The additional bending angle may vary according to a kind of the dental wire.

The required bending angle in accordance with the position of the dental wire may be determined by tooth status data obtained by three-dimensionally scanning a patient.

The additional bending angle may be determined by a table including a value of the additional bending angle corresponding to a value of the required bending angle.

Other features and aspects will be apparent from the following detailed description, the drawings, and the claims.

### BRIEF DESCRIPTION OF THE DRAWINGS

FIG. 1 is a diagram illustrating a bending angle control means 100 according to one embodiment of the present disclosure.

FIGS. 2 to 4 are diagrams illustrating a process of bending a wire in a wire bending apparatus to which the bending angle control means 100 is applied.

FIG. 5 is a flowchart illustrating a bending angle control method according to one embodiment of the present disclosure.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

Hereinafter, specific embodiments of the present disclosure will be described in accordance with the following drawings, however, they are only exemplary embodiments of the disclosure, and the present disclosure is not limited thereto.

Descriptions of well-known functions and constructions may be omitted for increased clarity and conciseness. Also, terms described in below are selected by considering functions in the embodiment and meanings may vary depending on, for example, a user or operator's intentions or customs. Therefore, definitions of the terms should be made on the basis of the overall context.

The spirit and scope of the disclosure are defined by the appended claims. The following embodiments are only made to efficiently describe the progressive technological scope of the present disclosure to those skilled in the art.

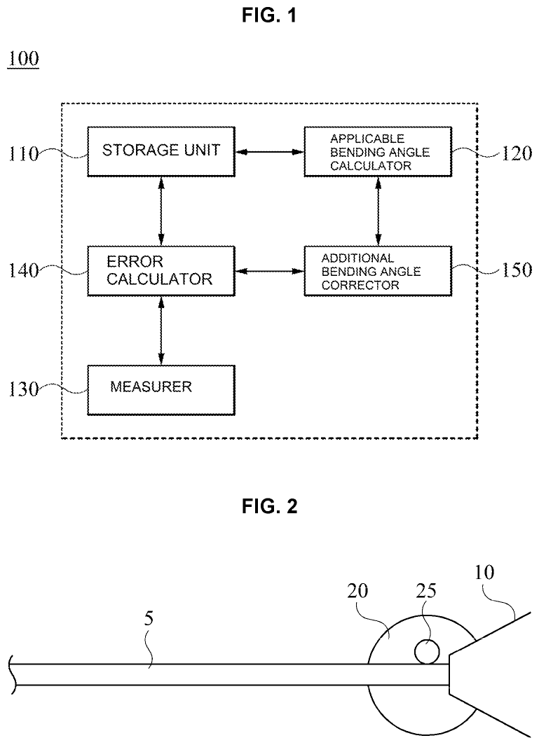

FIG. 1 is a diagram illustrating a bending angle control means 100 according to one embodiment of the present disclosure, and FIGS. 2 to 4 are diagrams illustrating a process of bending a wire 5 in a wire bending apparatus to which the bending angle control means 100 is applied.

Referring to FIGS. 1 to 4, the bending angle control means 100 according to one embodiment of the present disclosure may be applied to a dental wire bending apparatus which bends a dental wire into a predetermined shape which is suitable for orthodontics. As shown in FIG. 2, the dental wire bending apparatus may include a holding portion 10 which holds at least a part of an dental wire 5 to maintain a state suitable for bending and a bending portion 20 which bends the predetermined part of the wire 5 held by the holding portion 10. The bending portion 20 may be rotated by a rotation means, such as a motor (not shown), and a bending projection 25 eccentric to a rotation axis of the bending portion 20 pushes the dental wire 5 in a direction in which the dental wire 5 is to be bent, so that the dental wire 5 can be bent. A degree of bending of the dental wire 5 may be adjusted by a rotational angle of the bending portion 20. That is, as the bending angle of the dental wire 5 becomes greater, the rotational angle of the bending portion 20 is increased in proportion to the bending angle, so that a degree by which the bending projection 25 pushes the dental wire 5 can be increased.

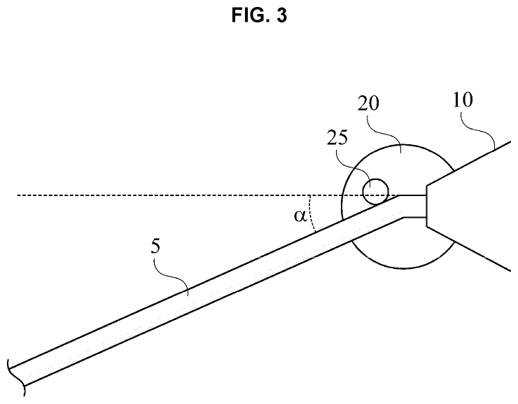

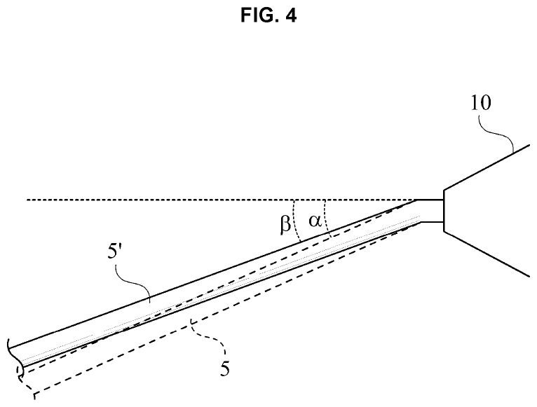

FIG. 3 illustrates a state in which the bending projection 25 of the bending portion 20 pushes the dental wire 5 and accordingly the dental wire 5 is bent at a predetermined first angle α. If the state in which the dental wire 5 is bent by the bending portion 20 is maintained, the bending portion 20 may bend the dental wire 5 only at an angle (required bending angle) at which the dental wire 5 needs to be bent. However, the dental wire 5 is formed of a metal material, and hence it may have a resilient restoring force. Thus, as shown in FIG. 4, even when the dental wire 5 is bent at the predetermined first angle α by the bending portion 20, an actual bending angle of the dental wire 5′ may not reach the first angle α, but is a second angle 3 due to the resilient restoring force. Therefore, when the dental wire 5 is bent, it may be desired to consider that the actual bending angle is not the first angle α, but the second angle 3. According to this fact, the second angle 3 of FIG. 4 may correspond to an angle (required bending angle) at which the dental wire 5 is to be bent and the first angle α may correspond to an angle (an applicable bending angle) at which the bending portion 20 bends the dental wire 5. In addition, a difference (a-n) between the first angle and the second angle may correspond to an additional bending angle obtained by taking into consideration the resilient restoring force of the dental wire 5.

The bending angle control means 100 that takes into account a bending characteristic of the dental wire 5 may include a storage unit 110 in which data related to a required bending angle in accordance with a position of the dental wire 5 is stored, an applicable bending angle calculator 120 configured to calculate an applicable bending angle obtained by adding an additional bending angle to the required bending angle in accordance with a position in consideration of the resilient restoring force of the dental wire 5, a measurer 130 configured to measure an actual bending angle of the dental wire 5 which is bent by the applicable bending angle, an error calculator 140 configured to calculate an error between the actual bending angle of the dental wire 5 and the required bending angle stored in the storage unit 100, and an additional bending angle corrector 150 configured to correct the additional bending angle by applying the calculated error.

That is, the bending angle control means 100 according to one embodiment of the present disclosure may serve to correct a deformation value of the dental wire 5 in order to ultimately bend the dental wire 5 by the required bending angle in consideration of the resilient restoring force of the dental wire 5. However, even when the deformation value of the dental wire 5 is corrected (additional bending angle), an actual bending angle may differ from the required bending angle, and hence feedback for continuously reducing an error between the actual bent angle and the required bending angle by performing additional correction may be carried out.

In this case, the resilient restoring force may vary according to the material and shape of the dental wire 5. Thus, when a kind of the dental wire 5 varies, an additional bending angle for the same required bending angle may vary according to the kind of the dental wire 5.

In addition, the required bending angle of the dental wire 5 may be determined according to a position of the dental wire 5 and a method of determining the position may be performed as follows:

(1) Three-dimensional (3D) scanning data of a patient's oral cavity may be acquired through a 3D scanner or the like.

(2) An imaginary plane corresponding to a position at which the dental wire is attached may be set in the 3D scanning data.

(3) A plurality of points may be set on a portion corresponding to back surfaces of teeth that meet the imaginary plane.

(4) A line connecting the plurality of point is formed and coordinates and a bent angle for a portion where the line is bent are calculated and stored as data.

In this case, the coordinates of the portion where the line is bent may become a bending position of the dental wire 5 and the bent angle may become a required bending angle at the corresponding position. However, the required bending angle of the dental wire 5 may not be obtained only by the method described above, and the required bending angle of the dental wire 5 may be obtained through various methods.

In addition, when the required bending angle is increased, an additional bending angle corresponding thereto may also be increased proportionally but roughly. As described above, a value of an additional bending angle for the same required bending angle may vary according to a kind of the dental wire 5. By taking all these factors into consideration, a table including values of additional bending angles in accordance with values of the required bending angles for each kind of dental wire 5 may be formed. Thus, when a kind of the dental wire 5 is determined, an additional bending angle for a required bending angle may be obtained using the table.

The measurer 130 may be configured to measure an actual bending angle from a bending state of the bent dental wire 5, photograph the bending state of the dental wire 5 through a camera or the like, set two imaginary straight lines for a bent portion of the dental wire 5 in the photographed image, and acquire the actual bending angle by measuring an angle between the two imaginary lines. However, a method by which the measurer 130 measures the actual bending angle is not limited thereto.

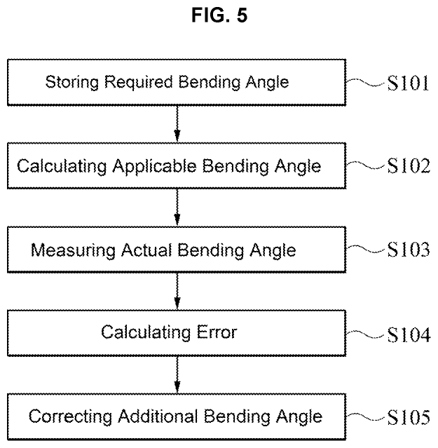

FIG. 5 is a flowchart illustrating a bending angle control method according to one embodiment of the present disclosure.

Referring to FIG. 5, the bending angle control method according to one embodiment of the present disclosure may include the following operations.

First, data on a required bending angle in accordance with a position of an dental wire 5 may be stored (S101).

Then, an applicable bending angle may be calculated by adding an additional bending angle to the required bending angle in accordance with the position of the dental wire 5 in consideration of a resilient restoring force (S102). Then, an actual bending angle of the dental wire 5 bent by the applicable bending angle may be measured (S103).

In addition, an error between the actual bending angle and the required bending angle may be calculated (S104).

Then, the additional bending angle may be corrected by applying the error (S105).

Through the above-described bending angle control method, the dental wire may be bent by calculating an applicable bending angle which is corrected in accordance with the resilient restoring force of the dental wire such that the dental wire can be bent at a desired angle despite the resilient restoring force of the dental wire. In addition, when, although the dental wire is bent by the calculated applicable bending angle, the actual bending angle is different from the required bending angle, feedback is performed to correct the difference, thereby adjusting the additional bending angle, so that the actual bending angle can match the required bending angle.

According to the embodiments of the present disclosure, it is possible to provide a bending angle control means applied to a wire bending apparatus capable of bending a dental wire by a predetermined angle at predetermined intervals of length and thereby automatically fabricating a dental wire in a predetermined shape, and a method of controlling a bending angle.

In addition, according to the embodiments of the present disclosure, it is possible to adjust a bending angle by accurately applying a resilient restoring force of a dental wire.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

1: A bending angle control means of a wire bending apparatus which comprises a holding portion configured to hold at least a part of a dental wire and a bending portion configured to bend a predetermined portion of the dental wire held by the holding portion, the bending angle control means comprising:
a storage unit in which data on a required bending angle in accordance with a position of the dental wire is stored;
a bending angle calculator configured to calculate an applicable bending angle by adding an additional bending angle to the required bending angle in accordance with the position of the dental wire in consideration of a resilient restoring force;
a measurer configured to measure an actual bending angle of the dental wire bent by the applicable bending angle;
an error calculator configured to calculate an error between the actual bending angle and the required bend angle; and
an additional bending angle corrector configured to correct the additional bending angle by applying the error.

2: The bending angle control means of claim 1, wherein the additional bending angle varies according to a kind of the dental wire.

3: The bending angle control means of claim 1, wherein the bending portion is rotated by a rotational force of a motor and a bending projection eccentric to a rotational axis of the bending portion pushes the dental wire so that the dental wire is bent.

4: The bending angle control means of claim 1, wherein the required bending angle in accordance with the position of the dental wire is determined by tooth status data obtained by three-dimensionally scanning a patient.

5: The bending angle control means of claim 1, wherein the additional bending angle is determined by a table including a value of the additional bending angle corresponding to a value of the required bending angle.

6: A bending angle control method of a wire bending apparatus which comprises a holding portion configured to hold at least a part of a dental wire and a bending portion configured to bend a predetermined portion of the dental wire held by the holding portion, the bending angle control method comprising:
storing data on a required bending angle in accordance with a position of the dental wire;
calculating an applicable bending angle by adding an additional bending angle to the required bending angle in accordance with the position of the dental wire in consideration of a resilient restoring force;
measuring an actual bending angle of the dental wire bent by the applicable bending angle;
calculating an error between the actual bending angle and the required bend angle; and
correcting the additional bending angle by applying the error.

7: The bending angle control method of claim 6, wherein the additional bending angle varies according to a kind of the dental wire.

8: The bending angle control method of claim 6, wherein the required bending angle in accordance with the position of the dental wire is determined by tooth status data obtained by three-dimensionally scanning a patient.

9: The bending angle control method of claim 6, wherein the additional bending angle is determined by a table including a value of the additional bending angle corresponding to a value of the required bending angle.
